(19) United States
(12) Patent Application Publication
(10) Pub. No.: US 2016/0246426 A1
(43) Pub. Date: Aug. 25, 2016

(54) ARRAY SUBSTRATE AND DISPLAY DEVICE

(71) Applicant: Shenzhen China Star Optoelectronics Technology Co., Ltd., Shenzhen, Guangdong (CN)

(72) Inventors: Wei Zhan, Shenzhen, Guangdong (CN); Zhiyuan Shen, Shenzhen, Guangdong (CN); Haibo Du, Shenzhen, Guangdong (CN)

(73) Assignee: Shenzhen China Star Optoelectronics Technology Co., Ltd., Shenzhen, Guangdong (CN)

(21) Appl. No.: 14/418,187

(22) PCT Filed: Jan. 20, 2015
(86) PCT No.: PCT/CN2015/071060

§ 371 Date: May 9, 2016

(30) Foreign Application Priority Data
Dec. 19, 2014 (CN) 201410799551.9

(51) Int. Cl. G06F 3/041; G06F 3/044

(52) U.S. Cl. CPC G06F 3/0416; G06F 3/044; G06F 3/0412; G06F 2203/04103; G06F 2203/04107

(57) ABSTRACT

An array substrate and a display device in the technical field of display can solve the technical problem of complexity of the process of manufacturing the array substrate in the existing in-cell technology. The array substrate comprises several pixel units each being provided with a thin film transistor (TFT). A light shielding layer is disposed under a low temperature poly-silicon of the TFT. The array substrate further comprises several common electrodes and several address lines. The address lines each are connected with a corresponding common electrode, and located at the same layer as the light shielding layer.

The present application claims benefit of Chinese patent application CN 201410799551.9, entitled “An Array Substrate and A Display Device” and filed on Dec. 19, 2014, the entirety of which is incorporated herein by reference.

1. Technical Field

The present disclosure relates to the technical field of display, and in particular to an array substrate and a display device.

2. Technical Background

As display technology develops, liquid crystal display devices have become the most common display devices.

On the other hand, as the popularization of smart electronic products, capacitive touch screens are also widely used in various electronic products, such as cell phone and tablet PC, and the like. At present, common capacitive touch screens usually use technologies including OGS (one glass solution), on-cell, and in-cell. As compared with OGS and on-cell technologies, in-cell technology has superior production process, as well as the advantages of light weight, better transmittance, and more stable structure, and the like.

In the process of implementing the present disclosure, the inventor found out that the prior art has at least the following problems: structures, such as address lines and corresponding insulation layers, should be added in an in-cell liquid crystal display device; and in the process of manufacturing an array substrate, at least one more photo engraving process (PEP) should be added. Therefore, the process of manufacturing the array substrate in the prior art is too complex.

### SUMMARY OF THE INVENTION

The objective of the present disclosure is to provide an array substrate and a display device for solving the technical problem of complex process of manufacturing the array substrate in the existing in-cell technology.

An array substrate is provided according to the present disclosure, comprising several pixel units, each being provided with a thin film transistor (TFT), wherein a light shielding layer is disposed under a low temperature poly-silicon (LTPS) of the thin film transistor; and the array substrate further comprises several common electrodes and several address lines, wherein the common electrodes each are used for providing common voltage for a corresponding pixel unit and generating touch-controlling signal, and the address lines each are connected with a corresponding common electrode, and are disposed in a same layer as the light shielding layer.

Further, each address line is, at a side edge thereof, provided with a projection, with which the common electrode is connected.

Further, the array substrate further comprises several scan lines and several data lines.

Preferably, the address lines are located right under the data lines.

Alternatively, the address lines are located right under the scan lines.

Preferably, the address lines are made of metallic material.

Further, the thin film transistor is a top gate thin film transistor.

Preferably, one common electrode corresponds to one or more of the pixel units.

A display device is further provided according to the present disclosure, comprising a color filter substrate and the array substrate.

Further, the display device is a fringe field switching liquid crystal display device.

The present disclosure has the following beneficial effects. Most thin film transistors using LTPS are top gate thin film transistors. In order to prevent the problem of photo-generated current in a channel region of the thin film transistor under illumination of a backlight, a light shielding layer is usually disposed under the LTPS.

In the array substrate according to the present disclosure, the address lines for transmitting the touch-controlling signal and the light shielding layer for shielding light are arranged in the same layer. Therefore, in the process of manufacturing the array substrate, the address lines and the light shielding layer can be formed in the same patterning procedure. Therefore, it is unnecessary to increase the number of patterning procedures in view of forming the address lines solely, whereby the process of manufacturing the array substrate can be simplified.

Other features and advantages of the present disclosure will be further explained in the following description and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE ACCOMPANYING DRAWINGS

In order to illustrate the technical solutions of the examples of the present disclosure more clearly, the accompanying drawings needed for describing the examples will be explained briefly. In the drawings:

FIG. 1 schematically shows a plan view of an array substrate according to an example of the present disclosure,

FIG. 2 schematically shows a cross section along line A-A in FIG. 1, and

FIG. 3 schematically shows a plan view of the array substrate according to another example of the present disclosure.

### DETAILED DESCRIPTION OF THE EMBODIMENTS

The present disclosure will be explained in detail with reference to the examples and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the examples may be combined together in any manner, and the technical solutions obtained in this manner all fall within the scope of the present disclosure.

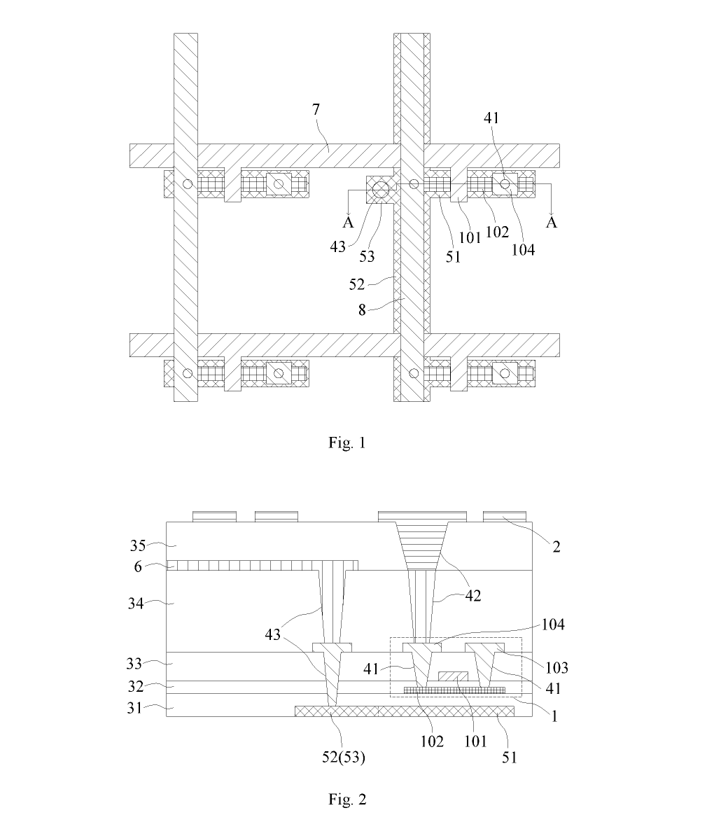

As shown in FIGS. 1 and 2, an array substrate is provided according to an example of the present disclosure, comprising several pixel units, each being provided with a thin film transistor 1 and a pixel electrode 2.

The thin film transistor in the present example is a top gate thin film transistor using low temperature poly-silicon (LTPS). A gate 101 of the thin film transistor is arranged above an LTPS 102, and an insulation layer 32 is arranged between the gate 101 and the LTPS 102. An insulation layer 33 is disposed above the gate 101. A source 103 and a drain 104 of the thin film transistor are disposed on the insulation layer 33, and connected with the LTPS 102 through a via hole 41. The pixel electrode 2 and the drain 104 are connected with each other through a via hole 42 which penetrates insulation layers 34 and 35.

A light shielding layer 51 is further disposed under the LTPS 102, and an insulation layer 31 is disposed between the light shielding layer 51 and the LTPS 102. The light shielding layer 51 is used to shield the LTPS 102 from light, so that photo-generated current can be prevented in a channel region of the thin film transistor under the illumination of a backlight.

The array substrate according to the present disclosure further comprises several common electrodes 6 and several address lines 52. The address lines 52 and the corresponding common electrodes 6 are connected through a via hole 43 which penetrates the insulation layers 31, 32, 33, and 34.

In use, time-sharing drive of display and touch control can be applied in the array substrate. When an image is displayed, the common electrode 6 provides common voltage to the corresponding pixel unit, so that an electric field can be formed between the common electrode 6 and the pixel electrode 2. In the meantime, one common electrode 6 can correspond to one or more pixel units. When a scanning is triggered through a touch, the common electrode 6 can be used as a touch sensor for generating touch-controlling signal.

According to the present example, the address lines 52 and the light shielding layer 51 are disposed in the same layer. The address lines 52 and the light shielding layer 51 are preferably made of metallic material, so that not only the light shielding effect of the light shielding layer 51 can be guaranteed, the reliability of the touch-controlling signal transmitted through the address lines 52 can also be ensured.

In the process of manufacturing the array substrate according to the example of the present disclosure, because the address lines 52 and the light shielding layer 51 are disposed in the same layer, they can be formed in a single patterning procedure. In this case, it is unnecessary to increase the number of patterning procedures in view of forming the address lines 52 solely, whereby the process of manufacturing the array substrate can be simplified.

In addition, since the number of patterning procedures according to the example of the present disclosure is reduced as compared with the prior art, the surface of the finished array substrate can be more smooth. As a result, the possibility of mura can be reduced, and the yield of the product can be improved.

The array substrate according to the example of the present disclosure further comprises several scan lines 7 and several data lines 8. In a preferred example, the address lines 52 are disposed right under the data lines 8, so that orthographic projections of the address lines 52 basically coincide with the data lines 8. Of course, the width of each address line 52 can be slightly different from that of the data line 8. As a result, the address lines 52 and the data lines 8 can be covered by a same black matrix on the color filter substrate, so that the aperture ratio of the entire liquid crystal display device would not be influenced due to the address lines 52.

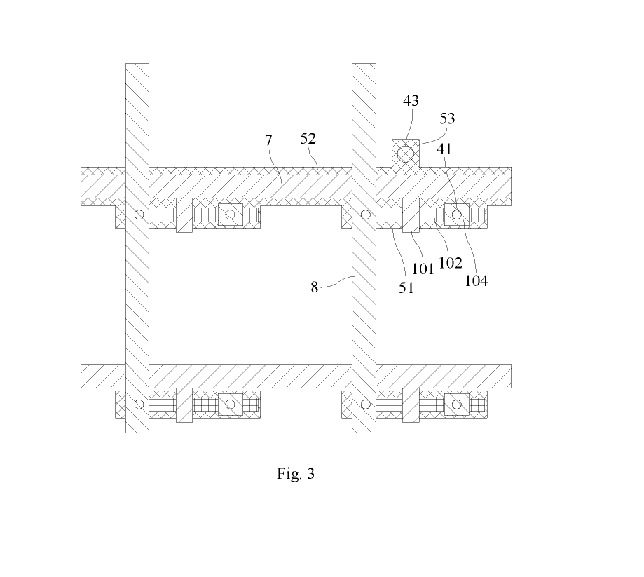

As shown in FIG. 3, in another example of the array substrate according to the present disclosure, the address lines 52 are disposed right under the scan lines 7, so that orthographic projections of the address lines 52 basically coincide with the scan lines 7. Of course, the width of each address line 52 can be slightly different from that of the scan line 7. As a result, the address lines 52 and the scan lines 7 can be covered by a same black matrix on the color filter substrate, so that the aperture ratio of the entire liquid crystal display device would not be influenced due to the address lines 52.

Further, each address line 52 is provided with a projection 53 at a side edge thereof. A via hole 43 is disposed on the projection 53, so that a corresponding common electrode 6 can be connected with the projection 53. It should be noted that although each projection 53 extends outside the main body of the address line 52 and occupies the aperture region of the pixel unit, the aperture ratio of the entire liquid crystal display device will barely be influenced because the area and the quantity of the projection 53 are both very small.

A display device is further provided according to the present disclosure. The display device can be a cell phone or a tablet PC, which has touch function and uses in-cell technology to realize the touch-control circuit. The display device comprises a color filter substrate and the array substrate according to the present disclosure.

The display device is preferably a fringe field switching (FFS) liquid crystal display device. The core technical characteristics of the display device can be described as follows: an electric field generated at an edge of slit-shaped pixel electrodes in the same plane enables liquid crystal molecules in all orientations disposed between and over the slit-shaped electrodes to rotate in plane, whereby a relative illuminance of the liquid crystal layer can be improved. A liquid crystal display device adopting FFS technology can have the advantages of high image quality, high resolution, high transmittance, low power consumption, wide viewing angle, high aperture ratio, low chromatic aberration, and ripple free under pressure, and the like.

The display device according to the present disclosure has the same technical feature as the array substrate according to the above example, and thus can solve the same technical problem and achieve the same technical effects.

The above embodiments are described only for better understanding, rather than restricting, the present disclosure. Any person skilled in the art can make amendments to the implementing forms or details without departing from the spirit and scope of the present disclosure. The scope of the present disclosure should still be subjected to the scope defined in the claims.

1. An array substrate, comprising several pixel units each being provided with a thin film transistor, wherein a light shielding layer is disposed under a low temperature poly-silicon of the thin film transistor, and
the array substrate further comprises several common electrodes and several address lines, wherein the common electrodes each are used for providing common voltage to a corresponding pixel unit and generating touch-controlling signal, and the address lines each are connected with a corresponding common electrode, and are disposed in a same layer as the light shielding layer.

2. The array substrate according to claim 1, wherein each address line is, at a side edge thereof, provided with a projection, with which the common electrode is connected.

3. The array substrate according to claim 1, further comprising several scan lines and several data lines.

4. The array substrate according to claim 3, wherein the address lines are located right under the data lines.

5. The array substrate according to claim 3, wherein the address lines are located right under the scan lines.

6. The array substrate according to claim 1, wherein the address lines are made of metallic material.

7. The array substrate according to claim 1, wherein the thin film transistor is a top gate thin film transistor.

8. The array substrate according to claim 1, wherein one common electrode corresponds to one or more of the pixel units.

9. A display device, comprising a color filter substrate and an array substrate, wherein
the array substrate comprises several pixel units, each being provided with a thin film transistor, wherein a light shielding layer is disposed under a low temperature polycrystalline silicon of the thin film transistor, and
the array substrate further comprises several common electrodes and several address lines, wherein the common electrodes each are used for providing common voltage to a corresponding pixel unit and generating touch-controlling signal, and the address lines each are connected with a corresponding common electrode, and are disposed in a same layer as the light shielding layer.

10. The display device according to claim 9, wherein each address line is provided with a projection, with which the common electrode is connected, at a side edge thereof.

11. The display device according to claim 9, wherein the array substrate further comprises several scan lines and several data lines.

12. The display device according to claim 11, wherein the address lines are located right under the data lines.

13. The display device according to claim 11, wherein the address lines are located right under the scan lines.

14. The display device according to claim 9, wherein the address lines are made of metallic material.

15. The display device according to claim 9, wherein the thin film transistor is a top gate thin film transistor.

16. The display device according to claim 9, wherein one common electrode corresponds to one or more of the pixel units.

17. The display device according to claim 9, the display device is a fringe field switching liquid crystal display device.
